(19) United States
(12) Patent Application Publication
(10) Pub. No.: US 2005/0216260 A1
(43) Pub. Date: Sep. 29, 2005

(54) Method and apparatus for evaluating speech quality

(75) Inventors: Ramkumar Ps, Bangalore (IN); Raghavendra Sagar, Bangalore (IN); Karthik Kannan, Bangalor (IN)

Correspondence Address: Lawrence Cho;c/o PortfolioIP, P.O. Box 52050, Minneapolis, MN, 55402, US

(73) Assignee: Intel Corporation

(21) Appl. No.: 10/811,208

(22) Filed: Mar. 26, 2004

(51) Int. Cl. G10L 19/00

(52) U.S. Cl. 704/213

(57) ABSTRACT

A method for processing speech data includes determining a presence of impulsive distortion in the speech data from root mean square (RMS) and zero crossing rate (ZCR) values of the speech data. For instance, in one embodiment determining the presence of impulsive distortion includes identifying a low ZCR value and a high RMS value. Other embodiments are described and claimed.

### TECHNICAL FIELD

Embodiments of the present invention pertain to speech quality evaluation techniques. More specifically, embodiments of the present invention relate to a method and apparatus for evaluating speech data for impulsive distortions.

### BACKGROUND

Advances in new speech processing systems have prompted the need for more robust speech quality evaluation systems. Such evaluation systems need to be accurate and robust in their measurements within stringent boundary conditions. For example, in characterizing a digital telephony system, the measurement of speech quality has to be independent of inherent channel distortions. In the past, both subjective and objective methods have been available to measure speech quality.

ITU recommendations P.800 (published August 1996) and P.830 (published February 1996) describe subjective methods for evaluating speech quality through the use of a team of expert listeners. The results of tests given to the team of expert listeners are averaged to give Mean Opinion Scores (MOS). Such tests have been found to be expensive and impractical to conduct in the field.

ITU-T P.862 (published February 2001) describes an objective method to evaluate speech quality referred to as Perceptual Evaluation of Speech Quality (PESQ). PESQ provides detailed scoring analysis that exposes voice quality impairments such as degraded voice clarity, delay, echo silence suppression, and signal loss. PESQ, however, suffers the drawback of being insensitive to detecting impulsive distortions. PESQ averages out impulsive distortions, such as spiky interference, that are present in speech data over time. Thus, the PESQ scores generated fail to accurately reflect the perceived speech quality of the speech data.

Thus, what is needed is an objective method and apparatus for evaluating speech data that effectively detects impulsive distortion.

### BRIEF DESCRIPTION OF THE DRAWINGS

The features and advantages of embodiments of the present invention are illustrated by way of example and are not intended to limit the scope of the embodiments of the present invention to the particular embodiments shown.

FIG. 1 illustrates a block diagram of a computer system in which an embodiment of the present invention resides in.

FIG. 2 is a block diagram of a speech evaluation unit according to an embodiment of the present invention.

FIGS. 3a-d illustrate exemplary forms of impulse distortion.

FIG. 4 is a block diagram of an impulsive distortion detection unit according to an embodiment of the present invention.

FIG. 5 is a block diagram of a speech quality measurement unit according to an embodiment of the present invention.

FIG. 6 is a flowchart diagram illustrating a method for detecting impulsive distortion according to a first embodiment of the present invention.

FIG. 7 is a flowchart diagram illustrating a method for detecting impulsive distortion according to a second embodiment of the present invention.

FIG. 8 is a flowchart diagram illustrating a method for detecting impulsive distortion according to a third embodiment of the present invention.

### DETAILED DESCRIPTION

In the following description, for purposes of explanation, specific nomenclature is set forth to provide a thorough understanding of embodiments of the present invention. However, it will be apparent to one skilled in the art that these specific details may not be required to practice the embodiments of the present invention. In other instances, well-known circuits, devices, and programs are shown in block diagram form to avoid obscuring embodiments of the present invention unnecessarily.

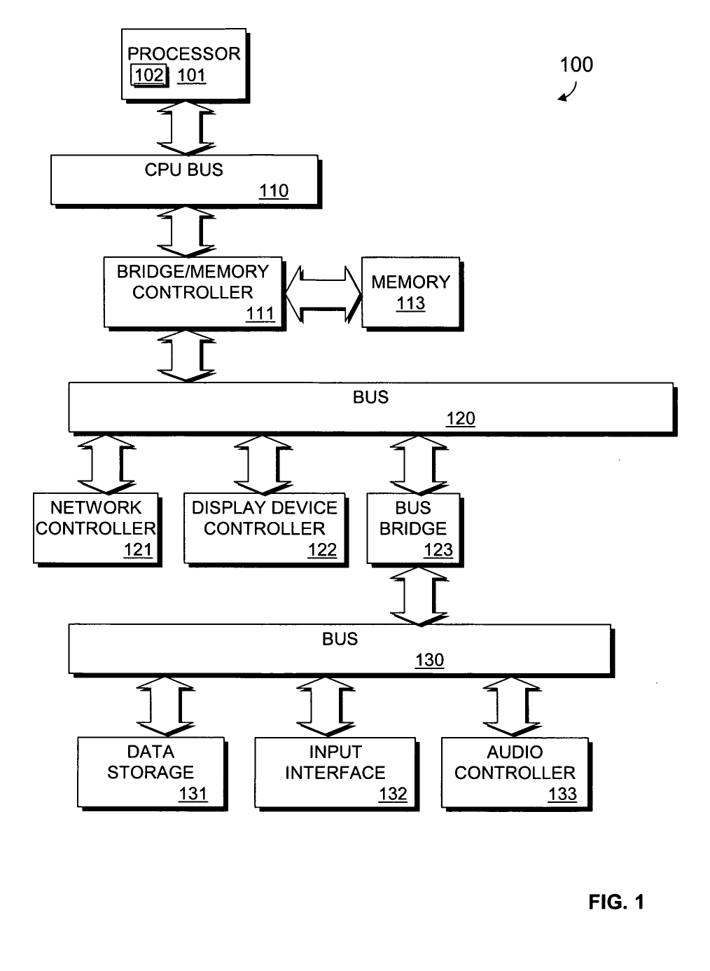

FIG. 1 is a block diagram of an exemplary computer system 100 in which an embodiment of the present invention resides in. The computer system 100 includes a processor 101 that processes data signals. The processor 101 may be a complex instruction set computer microprocessor, a reduced instruction set computing microprocessor, a very long instruction word microprocessor, a processor implementing a combination of instruction sets, or other processor device. FIG. 1 shows the computer system 100 with a single processor. However, it is understood that the computer system 100 may operate with multiple processors. The processor 101 is coupled to a CPU bus 110 that transmits data signals between processor 101 and other components in the computer system 100.

The computer system 100 includes a memory 113. The memory 113 may be a dynamic random access memory device, a static random access memory device, or other memory device. The memory 113 may store instructions and code represented by data signals that may be executed by the processor 101. A cache memory 102 resides inside processor 101 that stores data signals stored in memory 113. The cache 102 speeds up memory accesses by the processor 101 by taking advantage of its locality of access. In an alternate embodiment of the computer system 100, the cache 102 resides external to the processor 101. A bridge memory controller 111 is coupled to the CPU bus 110 and the memory 113. The bridge memory controller 111 directs data signals between the processor 101, the memory 113, and other components in the computer system 100 and bridges the data signals between the CPU bus 110, the memory 113, and a first input output (IO) bus 120.

The first IO bus 120 may be a single bus or a combination of multiple buses. The first IO bus 120 provides communication links between components in the computer system 100. A network controller 121 is coupled to the first IO bus 120. The network controller 121 may link the computer system 100 to a network of computers (not shown) and supports communication among the machines. A display device controller 122 is coupled to the first IO bus 120. The display device controller 122 allows coupling of a display device (not shown) to the computer system 100 and acts as an interface between the display device and the computer system 100.

A second IO bus 130 may be a single bus or a combination of multiple buses. The second IO bus 130 provides communication links between components in the computer system 100. A data storage device 131 is coupled to the second IO bus 130. The data storage device 131 may be a hard disk drive, a floppy disk drive, a CD-ROM device, a flash memory device or other mass storage device. An input interface 132 is coupled to the second IO bus 130. The input interface 132 may be, for example, a keyboard and/or mouse controller or other input interface. The input interface 132 may be a dedicated device or can reside in another device such as a bus controller or other controller. The input interface 132 allows coupling of an input device to the computer system 100 and transmits data signals from an input device to the computer system 100. An audio controller 133 is coupled to the second IO bus 130. The audio controller 133 operates to coordinate the recording and playing of sounds. A bus bridge 123 couples the first IO bus 120 to the second IO bus 130. The bus bridge 123 operates to buffer and bridge data signals between the first IO bus 120 and the second IO bus 130.

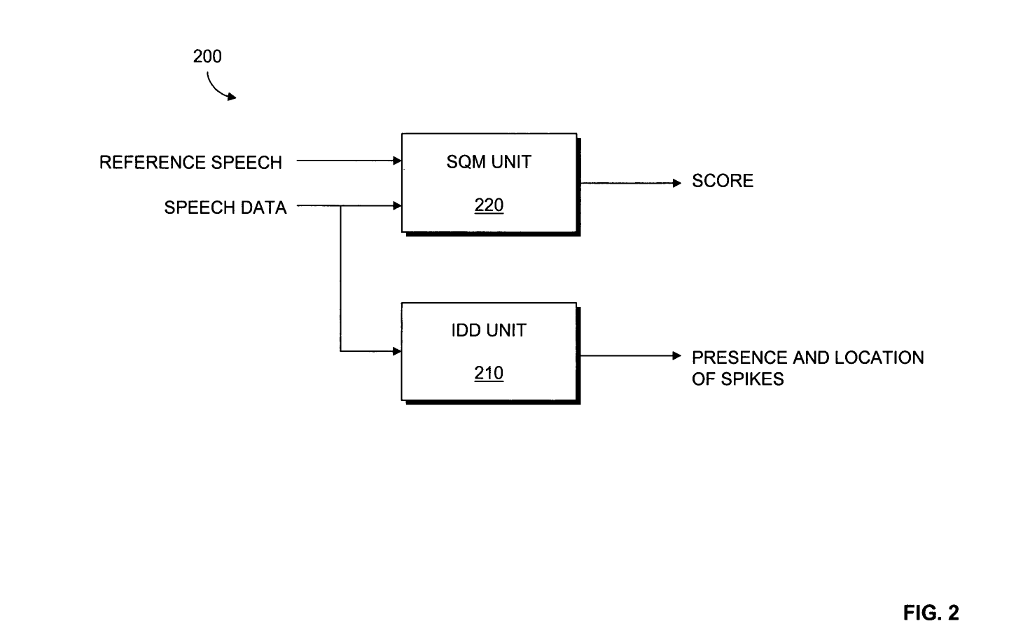

FIG. 2 is a block diagram of a speech evaluation unit 200 according to an embodiment of the present invention. The speech evaluation unit 200 provides an objective evaluation of speech data. The speech evaluation unit 200 may be used to evaluate speech data from communication systems utilizing Voice over Internet Protocol (VoIP), Voice over Asynchronous Transfer Mode (VoATM), Voice over Digital Subscriber Lines (VoDSL), or other techniques. The speech quality evaluation unit 200 includes a plurality of modules that may be implemented in software and reside in the memory 113 of the computer system 100 (shown in FIG. 1) as sequences of instructions. Alternatively, it should be appreciated that the modules of the speech quality evaluation unit 200 may be implemented as hardware or a combination of both hardware and software. The speech quality evaluation unit 200 includes an impulse distortion detection (IDD) unit 210. Impulse distortion may take the form of spikes in speech data.

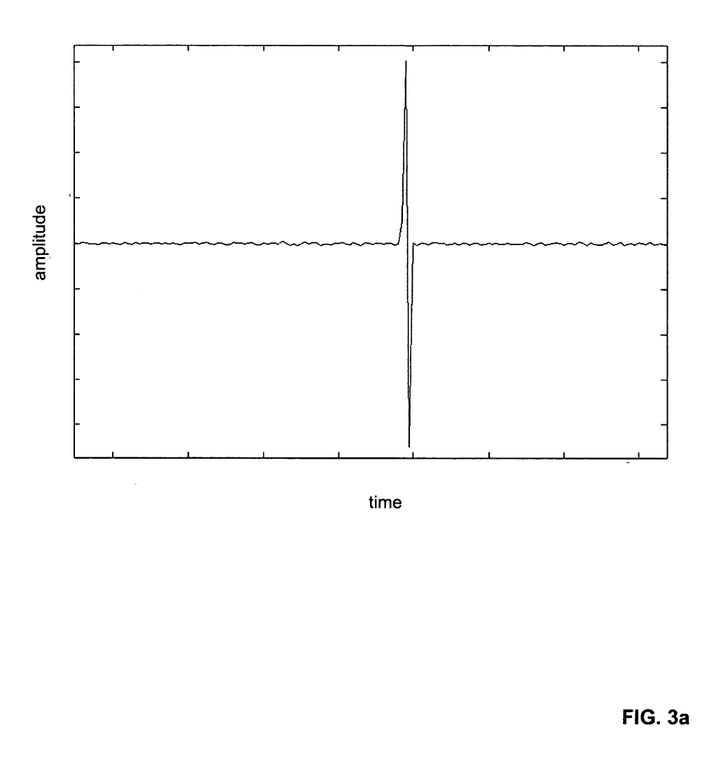

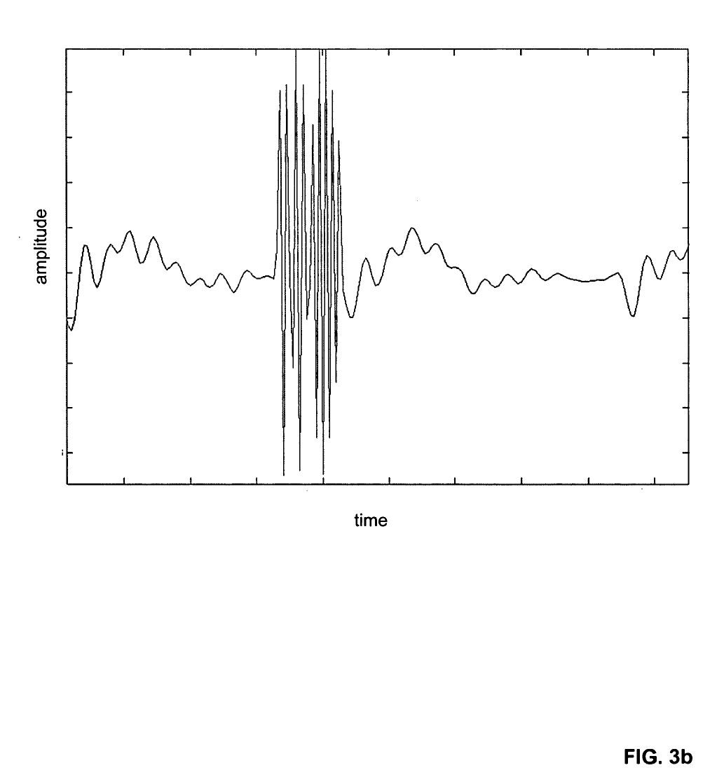

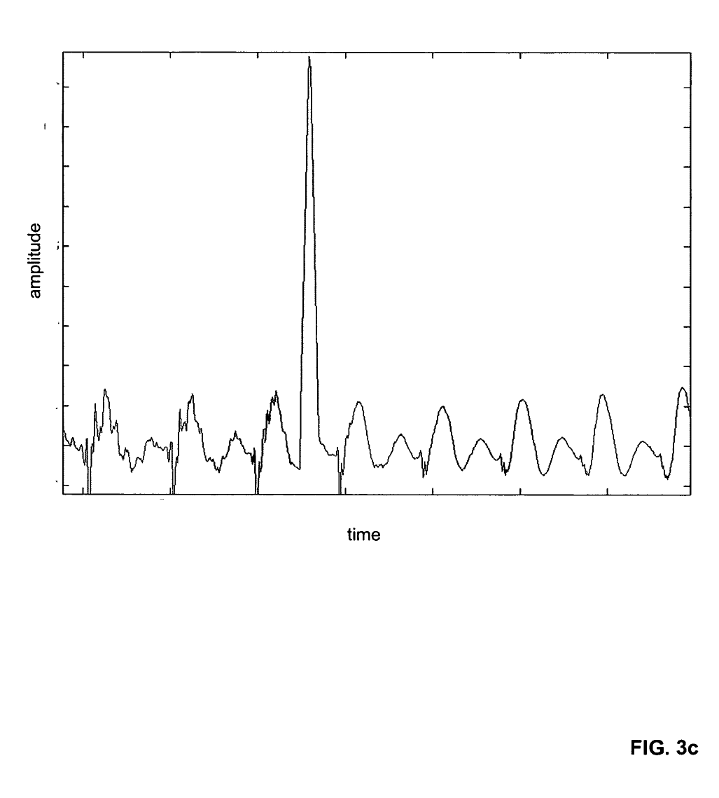

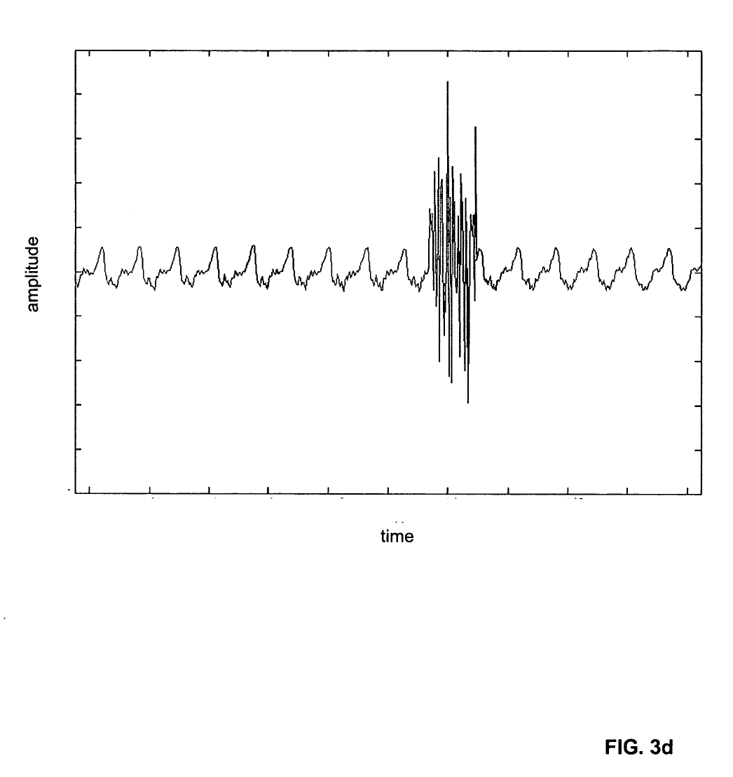

FIGS. 3a-d illustrate exemplary forms of impulse distortion. FIG. 3a illustrates spikes that have the characteristic of an impulse having very short duration and a high amplitude (type W spikes). FIG. 3b illustrates spikes having the characteristic of an unexpected tone content (type Z spikes). FIG. 3c illustrates spikes having the characteristic of a bell shape (type X spikes). These types of spikes may occur, for example, due to saturation of a speech signal or interference introduced in the channel during transmission. These spikes may also be rectangular or triangular shaped. FIG. 3d illustrates spikes having the characteristic of noise (type Y spikes).

Referring back to FIG. 2, the impulse distortion detection unit 210 receives speech data and determines whether impulse distortion is present in the speech data. According to an embodiment of the speech quality evaluation unit 200, the impulse distortion detection unit 210 makes this determination in response to sample energy values, root means square (RMS) values, and/or RMS and zero crossing (ZCR) values corresponding to the speech data. In addition to determine the presence of impulse distortion, the impulse distortion detection unit 210 may also determine a location of the impulse distortion in the speech data.

The speech evaluation unit 200 includes a speech quality measurement unit 220. The speech quality measurement (SQM) unit 220 compares the speech data with a reference speech and generates a score that indicates the quality of the speech data. According to an embodiment of the speech evaluation unit 200, the speech quality measurement unit 220 evaluates the speech data for degraded voice clarity, delay, echo, silence suppression, and signal loss. The speech quality measurement unit 220 may, for example, utilize the techniques specified in ITU-T P.862 (PESQ), ITU-T P.861 (PSQM) (published 1996), or other techniques.

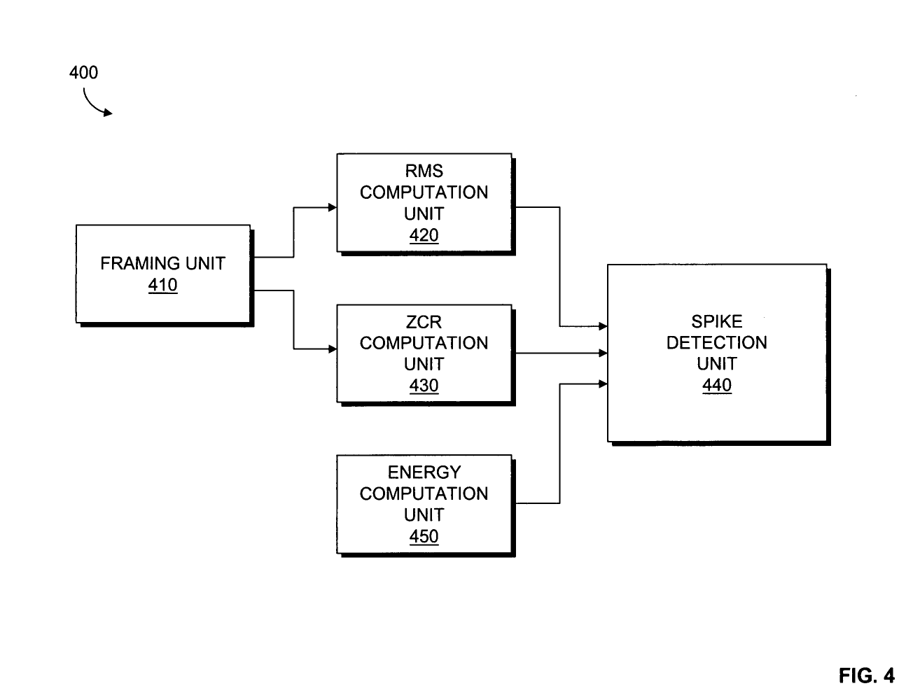

FIG. 4 is a block diagram of an impulsive distortion detection unit 400 according to an embodiment of the present invention. The impulsive distortion unit 400 may be implemented as the impulsive distortion detection unit 210 shown in FIG. 2. The impulsive distortion detection unit 400 includes a framing unit 410. The framing unit 410 receives the speech data and allocates the speech data into frames for processing. According to an embodiment of the impulsive distortion unit 400, the framing unit 410 overlaps frames such that a set of speech data may be allocated to more than one frame. According to an embodiment of the present invention, a first frame of speech data may include speech data sampled at time 1 to time 10, a second frame of speech data may include speech data sampled from time 6 to time 15, and a third frame of speech data may include speech data sampled from time 11 to time 20. It should be appreciated that other framing techniques may be utilized by the framing unit 410.

The impulsive distortion detection unit 400 includes a RMS computation unit 420. The RMS computation unit 420 computes a RMS value for each frame of speech data received from the framing unit 410. The RMS value measures the strength of the signal in each frame. A high RMS value indicates a high-energy signal frame. According to an embodiment of the RMS computation unit 420, the RMS value for a frame i is computed as shown below.

$${RMS}_{i} = k * \sqrt{( 1 / N ) \{ {\sum }_{n = 0}^{N - 1} {x}_{i}^{2} ( n ) \}} ,$$

where N is number of samples in a frame.

RMSᵢ=RMS value of the i^{th} frame.

xᵢ(n) is the n^{th} speech sample in iₜₕ frame.

k is a constant.

The impulsive distortion detection unit 400 includes a ZCR computation unit 430. The ZCR computation unit 430 computes a ZCR value for each frame of speech data received from the framing unit 410. The ZCR value measures the rate at which a speech signal switches across its mean value for the frame. Noisy signals are random in nature and typically have a high ZCR value. Speech signals characterized by quasi-periodicity typically have lower ZCR and change very slowly with time. The ZCR computation unit 430 generates a ZCR value that is normalized by its frame width. ZCRᵢ is the ZCR value of frame i in the speech data.

The impulsive distortion detection unit 400 includes a spike detection unit 440. According to an embodiment of the impulse distortion detection unit 400, the spike detection unit 440 is capable of detecting the presence of type X spikes as described and illustrated with reference to FIG. 3c. In this embodiment, the spike detection unit 440 determines the presence of type X spikes in a frame of speech data when the RMS value in the frame is greater than a first predetermined value and the ZCR value in the frame is less than a second predetermined value. The predetermined values may be set such that type X spikes are determined when a high RMS value and a low ZCR value are present. The first predetermined value may be, for example, 0.6, and the second predetermined value may be, for example, 0.1.

According to an embodiment of the impulse distortion detection unit 400, the spike detection unit 440 is capable of detecting the presence of type Y and/or type Z spikes as described and illustrated with reference to FIGS. 3b and 3d. In this embodiment, the spike detection unit 440 determines the presence of type Y and/or type Z spikes in a frame of speech data when the RMS value in the frame is greater than a third predetermined value and the ZCR value in the frame is greater than a fourth predetermined value. The predetermined values may be set such that type Y and/or type Z spikes are determined when a high ZCR value and a medium to high RMS value are present. The third predetermined value may be, for example, 0.2, and the fourth predetermined value may be, for example, 0.4.

The spike detection unit 440 may also detect the presence of Y and/or type Z spikes in a frame of speech data by evaluating the RMS values of the frame and the RMS values of its neighboring frames. In one embodiment, the spike detection unit 440 detects a presence of Y and/or type Z spikes in a frame n of speech data when a difference in a RMS value for the frame n and a RMS value for a frame n−2 is greater than a fifth predetermined value, a difference in the RMS value for the frame n and a RMS value for the frame n+2 is more than a sixth predetermined value, and a difference in RMS values for frames n−4 and n−2 and a difference in RMS values for frames n+4 and n+2 are less than a seventh predetermined value. The type of Y and/or Z type spikes that satisfy these conditions may be large spikes present in pure speech or background noise that is noticeable to the human ear.

In a second embodiment, the spike detection unit 440 detects a presence of type Y and/or type Z spikes in a frame n of speech data when a RMS value for frames n−4, n−2, n, n+2, or n+4 is greater than an eighth predetermined value. The eighth predetermined value may be, for example, 0.5. The type of Y and/or Z type spikes that satisfy this condition may be a spike present in pure speech and due to saturation.

The impulsive distortion detection unit 400 includes an energy computation unit 450. The energy computation unit 450 computes a sample energy value of a speech sample. According to an embodiment of the impulse distortion detection unit 400, the energy computation unit 450 computes a Teager sample energy value using the Teager energy operator. According to an embodiment of the present invention, the Teager energy operator is described below.
ψ(n)=x²(n)−x(n−1)*x(n+1)
ψ(n) is a Teager sample energy of speech sample x(n).

The Teager energy operator generates a Teager sample energy value that emphasizes fast variations and deemphasizes slow variations in speech signal amplitude. Teager sample energy values will indicate sharp rises/falls when speech samples vary significantly in amplitude with respect to adjacent samples. The presence of sharp rises/falls in Teager sample energy values indicates a probable presence of a spike. It should be appreciated that other energy operators may also be used by the energy computation unit 450.

The spike detection unit 440 evaluates sample energy value generated for a speech sample at a position q with respect to sample energy values of neighboring speech samples. If any of the neighboring sample energy values is less than the sample energy value at position q by a ninth predetermined value, the spike detection unit 440 determines that a spike is present. According to an embodiment of the present invention, exemplary positions of neighboring speech samples may be at positions q−2, q−1, q+1, and q+2, and an exemplary ninth predetermined value is 0.35. In addition to detecting the presence of an impulsive distortion in speech data, the spike detection unit 440 may also generate an indication as to a relative position of the impulsive distortion.

According to an embodiment of the present invention, the spike detection unit 440 and the energy computation unit 450 operate such that the energy computation unit 450 computes sample energy values for speech data where type X, Y, and/or Z spikes are not detected. In this embodiment, the spike detection unit 440 forwards information regarding speech data where X, Y, and/or Z spikes have been detected to the energy computation unit 450.

The predetermined values described with reference to FIG. 4 have been described with reference to an order, one to nine. It should be appreciated that the order need not correspond to the magnitude of the value. It should also be appreciated that predetermined values having a different order may have the same value.

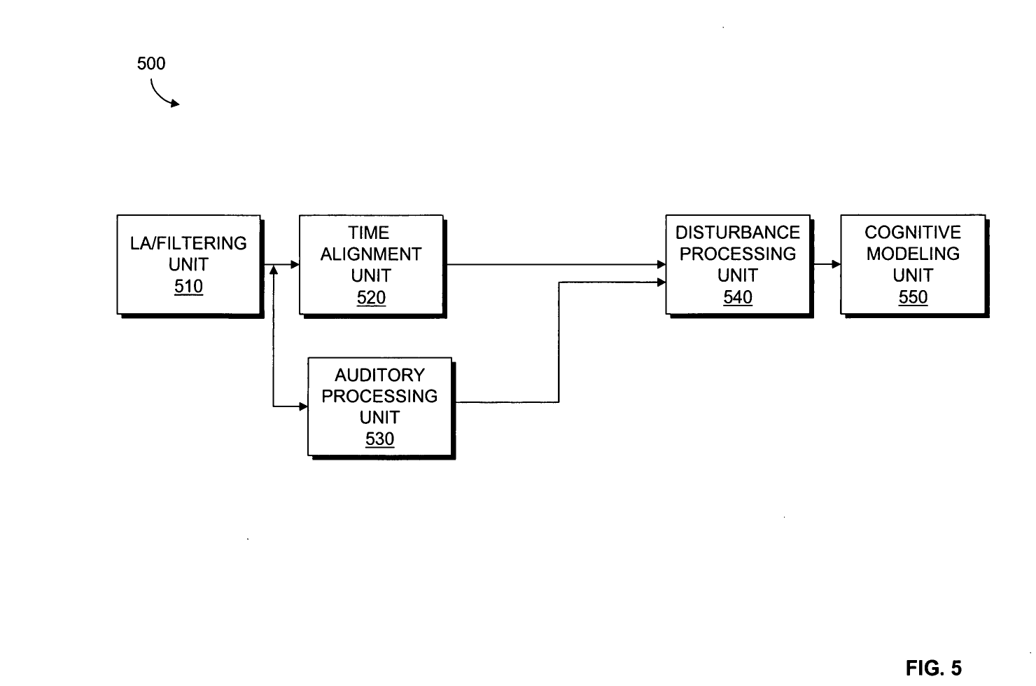

FIG. 5 is a block diagram of a speech quality measurement unit 500 according to an embodiment of the present invention. The speech quality measurement unit 500 may be used to implement the speech quality measurement unit 220 (shown in FIG. 2). The speech quality measurement unit 500 includes a level alignment (LA)/filtering unit 510. The level alignment/filtering unit 510 receives the speech data and reference speech and performs level alignment to bring both the speech data and reference speech to a same relative power level. According to an embodiment of the present invention, the speech data and reference speech are normalized. The alignment/filtering unit 510 also applies a filter to the speech data and the reference speech to filter out of band components.

The speech quality measurement unit 500 includes a time alignment unit 520. The time alignment unit 520 measures the difference in timing between the speech data and the reference speech and determines any delay present. The delay may be used to adjust either the speech data or the reference speech such that they may be processed more accurately by the speech quality measurement unit 500.

The speech quality measurement unit 500 includes an auditory processing unit 530. The auditory processing unit 530 performs an auditory transform on the speech data and the reference speech. The auditory transform boosts components in the speech data and the reference speech that are audible to human hearing. The auditory processing unit 530 generates a sensation surface for the speech data and the reference speech. The sensation surfaces represent the speech data and the reference speech in time and frequency.

The speech quality measurement unit 500 includes a disturbance processing unit 540. The disturbance processing unit 540 receives the sensation surfaces of the speech data and the reference speech from the auditory processing unit 530 and the delay of the speech data and the reference speech from the time alignment unit 520. The disturbance processing unit 540 evaluates the sensation surfaces and generates an error surface that indicates the audible differences between the speech data and the reference data.

The speech quality measurement unit 500 includes a cognitive modeling unit 550. The cognitive modeling unit 550 generates a score that indicates the quality of the speech signal from the error surface received from the disturbance processing unit 540.

It should be appreciated that the speech quality measurement unit 500 may include additional modules, components or mechanisms. For example, the auditory processing unit 530 and/or the disturbance processing unit 540 may feedback data to the time alignment unit 520 to allow calibration of the time alignment unit 520 that would produce more accurate delay measurements. The framing unit 410, RMS computation unit 420, ZCR computation unit 430, spike detection unit 440, and energy computation unit 450 (shown in FIG. 4), and the LA/filtering unit 510, time alignment unit 520, auditory processing unit 530, disturbance processing unit 540, and cognitive modeling unit 550 may be implemented using any known technique or circuitry.

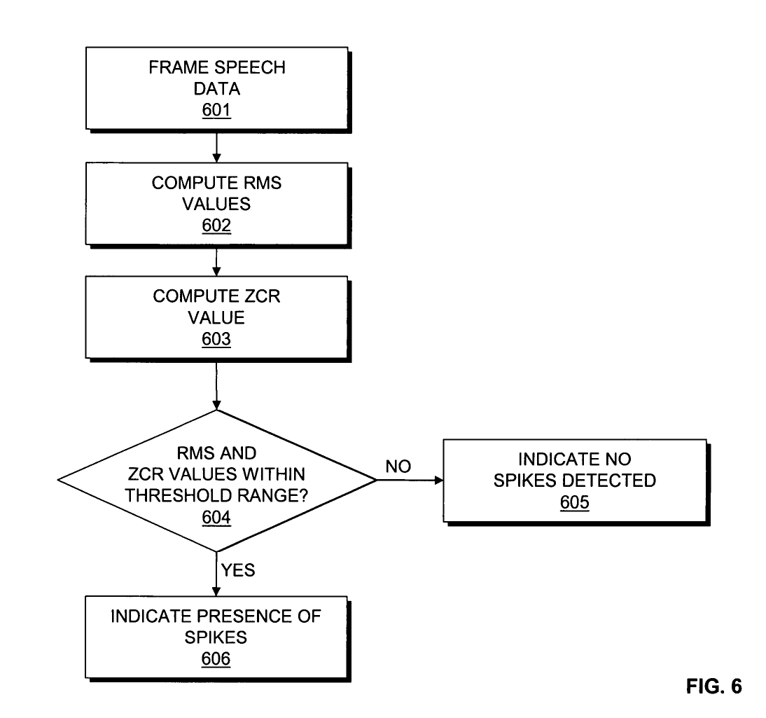

FIG. 6 is a flowchart diagram illustrating a method for detecting impulsive distortion according to a first embodiment of the present invention. At 601, speech data is framed. According to an embodiment of the present invention, the speech data is allocated to overlapping frames such that a set of speech data may be allocated to more than one frame. In one embodiment, each frame between a first and last frame generated overlaps with 50% of two other frames.

At 602, an RMS value is computed for each frame of speech data. According to an embodiment of the present invention, the RMS value for a frame i is computed as shown below.

$${RMS}_{i} = k * \sqrt{( 1 / N ) \{ {\sum }_{n = 0}^{N - 1} {x}_{i}^{2} ( n ) \}} ,$$

where N is number of samples in a frame.
RMSᵢ=RMS value of the i^{th} frame.
xᵢ(n) is the n^{th} speech sample in i^{th} frame.
k is a constant.

According to an embodiment of the present invention, the constant k may be set to 2.

At 603, a ZCR value is computed for each frame of speech data. The ZCR value indicates the rate at which a speech signal switches across its mean value for the frame.

At 604, it is determined whether RMS and ZCR values for a frame of speech data is within a range defined by predetermined values. A first range may be defined to determine the presence of type X spikes as described and illustrated with reference to FIG. 3c. RMS and ZCR values are in the first range when the RMS value in the frame is greater than a first predetermined value and the ZCR value in the frame is less than a second predetermined value. According to one embodiment, the first predetermined value may be, for example, 0.6, and the second predetermined value may be, for example, 0.1.

A second range may be defined to determine the presence of type Y and/or type Z spikes as described and illustrated with reference to FIGS. 3b and 3d. RMS and ZCR values are in the second range when the RMS value in the frame is greater than a third predetermined value and the ZCR value in the frame is greater than a fourth predetermined value. The predetermined values may be set such that type Y and/or type Z spikes are determined when a high ZCR value and a medium to high RMS value are present. According to one embodiment, the third predetermined value may be, for example, 0.2, and the fourth predetermined value may be for example, 0.4.

If it is determined that the RMS and ZCR values for a frame of speech data is not within a range defined by predetermined values control proceeds to 605. If it is determined that the RMS and ZCR values for a frame of speech data is within a range defined by predetermined values control proceeds to 606.

At 605, an indication is generated to indicate that no spikes were detected.

At 606, an indication is generated to indicate that spikes were detected. A location of the spikes may also be provided by providing information about the frame i.

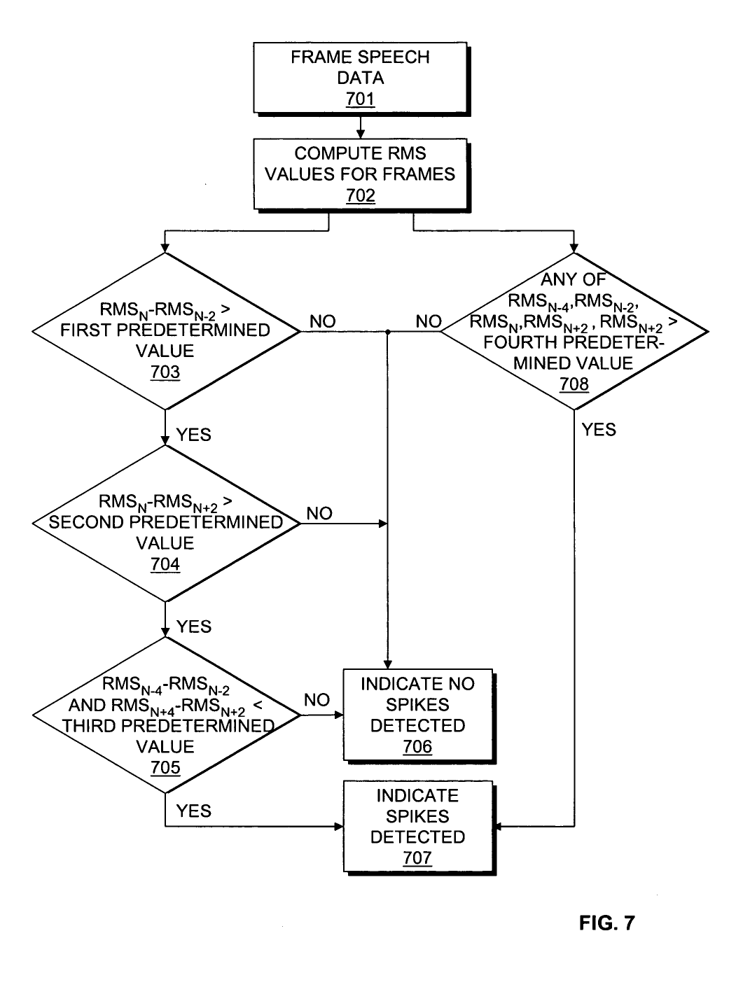

FIG. 7 is a flowchart diagram illustrating a method for detecting impulsive distortion according to a second embodiment of the present invention. It should be appreciated that the method shown in FIG. 7 may be used in conjunction with the method shown in FIG. 6. At 701, speech data is framed. According to an embodiment of the present invention, the speech data may be framed as described at 601 (shown in FIG. 6).

At 702, an RMS value is computed for each frame of speech data. According to an embodiment of the present invention, the RMS value for a frame may be computed as described at 602 (shown in FIG. 6).

At 703, it is determined whether a difference in a RMS value for a frame n and a RMS value for a frame n−2 is greater than a first predetermined value. If the difference is not greater than the first predetermined value, control proceeds to 706. If the difference is greater than the first predetermined value, control proceeds to 704.

At 704, it is determined whether a difference in the RMS value for the frame n and a RMS value for the frame n+2 is greater than a second predetermined value. If the difference is not greater than the second predetermined value, control proceeds to 706. If the difference is greater than the second predetermined value, control proceeds to 705.

At 705, it is determined whether a difference in RMS values for frames n−4 and n−2 and the difference in RMS values for frames n+4 and n+2 are less than a third predetermined value. If the differences are not less than the third predetermined value, control proceeds to 706. If the differences are less than the third predetermined value, control proceeds to 707.

At 706, an indication is generated to indicate that spikes have not been detected.

At 707, an indication is generated to indicate that spikes have been detected. A location of the spikes may also be provided by providing information about the frame n.

At 708, it is determined whether a RMS value for frames n−4, n−2, n, n+2, or n+4 is greater than a fourth predetermined value. The fourth predetermined value may be, for example, 0.5. If an RMS value for the frames is not greater than the fourth predetermined value, control proceeds to 706. If an RMS value for the frames is greater than the fourth predetermined value, control proceeds to 707.

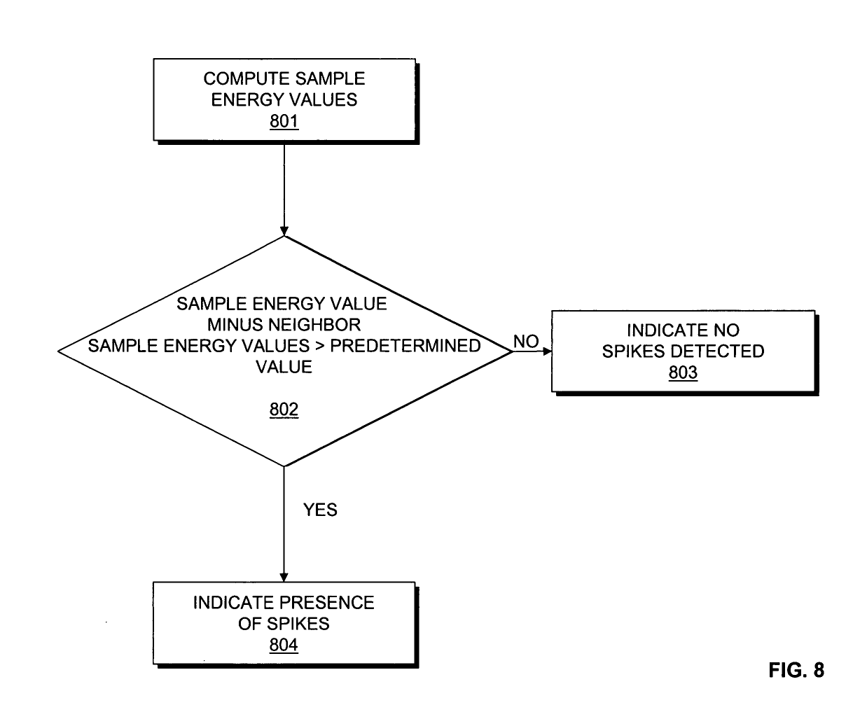

FIG. 8 is a flowchart diagram illustrating a method for detecting impulsive distortion according to a third embodiment of the present invention. At 801, a sample energy value is computed for a sample of speech data and neighboring samples. The Teager operator may be used to compute a Teager sample energy value. The Teager energy operator may be described as ψ(n)=x²(n)−x(n−1)*x(n+1), where ψ(n) is a Teager sample energy of speech sample x(n).

At 802, it is determined whether any of the sample energy values corresponding to a neighboring speech sample is less than the sample energy value of the speech sample at position q by a predetermined value. According to an embodiment of the present invention, exemplary positions of neighboring speech samples may be at positions q−2, q−1, q+1, and q+2, and an exemplary ninth predetermined value is 0.35. If any of sample energy values corresponding to the neighboring speech samples is not less than the sample energy value of the speech sample at position q by a predetermined value, control proceeds to 803. If any of sample energy values corresponding to the neighboring speech samples is less than the sample energy value of the speech sample at position q by a predetermined value, control proceeds to 804.

At 803, an indication is generated to indicate that no spikes have been detected.

At 804, an indication is generated to indicate that spikes have been detected. A location of the spikes may also be provided.

FIGS. 6-8 describe methods for detecting impulsive distortion according to embodiments of the present invention. The figures make reference to predetermined values, some of which include an assigned order. It should be appreciated that the order is re-assigned with each figure and that although an order may be referenced in more than one of the figures, the values associated with the order need not be the same. Furthermore, it should be appreciated that an order need not correspond to the magnitude of a predetermined value and that predetermined values having a different order may or may not have a different value.

FIGS. 6-8 are flow charts illustrating embodiments of the present invention. Some of the procedures illustrated in the figures may be performed sequentially, in parallel or in an order other than that which is described. It should be appreciated that not all of the procedures described are required, that additional procedures may be added, and that some of the illustrated procedures may be substituted with other procedures.

In the foregoing specification, the embodiments of the present invention have been described with reference to specific exemplary embodiments thereof. It will, however, be evident that various modifications and changes may be made thereto without departing from the broader spirit and scope of the embodiments of the present invention. The specification and drawings are, accordingly, to be regarded in an illustrative rather than restrictive sense.

1. A method for processing speech data, comprising:
determining a presence of impulsive distortion in the speech data from root mean square (RMS) and zero crossing rate (ZCR) values of the speech data.

2. The method of claim 1, further comprising framing the speech data.

3. The method of claim 1, wherein determining the presence of impulsive distortion comprises identifying a low ZCR value and a high RMS value.

4. The method of claim 1, wherein determining the presence of impulsive distortion comprises identifying a high ZCR value and a medium to high RMS value.

5. The method of claim 2, wherein the RMS value is computed for a frame of the speech data and indicates a strength of a speech signal in the frame.

6. The method of claim 2, wherein the ZCR value is computed for a frame of the speech data and indicates a rate at which a speech signal switches across its mean value in the frame.

7. The method of claim 1, further comprising determining the presence of impulsive distortion in the speech data from a sample energy value of a speech sample from the speech data.

8. The method of claim 1, further comprising performing a perceptual speech quality measurement on the speech data.

9. An automated method for processing speech data, comprising:
performing speech quality measurement on the speech data; and
determining a presence of impulsive distortion in the speech data.

10. The method of claim 9, wherein performing the speech quality measurement on the speech data comprises:
performing level alignment and filtering;
performing time alignment;
performing auditory processing;
performing disturbance processing; and
performing cognitive modeling.

11. The method of claim 9, wherein determining the presence of impulse distortion in the speech data comprises determining a sample energy value of a speech sample.

12. The method of claim 11, wherein determining the presence of impulse distortion in the speech data further comprises comparing the sample energy value of the speech sample with sample energy values of neighboring speech samples to determine whether there is a difference greater than a predetermined threshold value.

13. The method of claim 11, wherein determining the sample energy value of the speech sample comprises performing a Teager energy operator.

14. The method of claim 9, wherein determining the presence of impulse distortion in the speech data comprises:
determining if a difference in a root mean square (RMS) value for a frame k and a RMS value for a frame k−2 is greater than a first predetermined value and a difference in a RMS value for the frame k and a RMS value for a frame k+2 is more than a second predetermined value;
determining if a difference in RMS values for frames k−4 and k−2 and a difference in RMS values for frames k+4 and k+2 are less than a third predetermined value.

15. The method of claim 9, wherein determining the presence of impulse distortion in the speech data comprises determining if a root mean square (RMS) value for frames k−4, k−2, k, k+2, or k+4 is greater than a predetermined value.

16. The method of claim 9, wherein determining the presence of impulsive distortion in the speech data comprises determining root mean square (RMS) and zero crossing rate (ZCR) values of the speech data.

17. The method of claim 16, further comprising framing the speech data.

18. The method of claim 16, further comprising identifying a low ZCR value and a high RMS value.

19. The method of claim 16, further comprising identifying a high ZCR value and a medium to high RMS value.

20. The method of claim 16, wherein the RMS value is computed for a frame of the speech data and indicates a strength of a speech signal in the frame.

21. The method of claim 16, wherein the ZCR value is computed for a frame of the speech data and indicates a rate at which a speech signal switches across its mean value in the frame.

22. An article of manufacture comprising a machine accessible medium including sequences of instructions, the sequences of instructions including instructions which when executed causes the machine to perform:
determining a presence of impulsive distortion in speech data from root mean square (RMS) and zero crossing rate (ZCR) values of the speech data.

23. The article of manufacture of claim 22, further comprising sequences of instructions including instructions which when executed performs framing the speech data.

24. The article of manufacturer of claim 22, wherein determining the presence of impulsive distortion comprises identifying a low ZCR value and a high RMS value.

25. The article of manufacturer of claim 22, wherein determining the presence of impulsive distortion comprises identifying a high ZCR value and a medium to high RMS value.

26. The article of manufacture of claim 22, further comprising sequences of instructions including instructions which when executed performs determining the presence of impulsive distortion in the speech data from a sample energy value of a speech sample from the speech data.

27. An impulsive distortion detection unit, comprising:
a root mean square (RMS) computation unit to generate a RMS value for a frame of speech data;
a zero crossing (ZCR) computation unit to generate a ZCR value for the frame of speech data; and
a spike detection unit to determine a presence of impulsive distortion in the frame in response to the RMS value and the ZCR value.

28. The impulsive distortion detection unit of claim 27, wherein the spike detection unit determines the presence of the impulsive distortion in the frame by identifying a low ZCR value and a high RMS value.

29. The impulsive distortion detection unit of claim 27, wherein the spike detection unit determines the presence of the impulsive distortion in the frame by identifying a high ZCR value and a medium to high RMS value.

30. The impulsive distortion detection unit of claim 27, further comprising a framing unit to generate frames of speech data from speech data.

31. The impulsive distortion detection unit of claim 27, further comprising an energy computation unit to generate a sample energy value of a speech sample.

32. The impulsive distortion detection unit of claim 31, wherein the spike detection unit determines a presence of impulsive distortion in the speech sample in response to the sample energy value and the sample energy values of speech samples neighboring the speech sample.
